(19) United States
(12) Patent Application Publication
(10) Pub. No.: US 2024/0160840 A1
(43) Pub. Date: May 16, 2024

(54) ONLINE REAL-TIME INTERACTIVE COLLABORATIVE ANNOTATION SYSTEM

(71) Applicant: MARKADOC CORPORATION, Rochester, NY (US)

(72) Inventors: Shawn Jamison Mott, Rochester, NY (US); Tilo Schrodt, Rochester, NY (US); Cory Janick, Rochester, NY (US); Timothy A. Bissell, Hamlin, NY (US); Pete Meagher, Rochester, NY (US); Michael Clark, Rochester, NY (US); Yanika Telus, Rochester, NY (US); Colleen Simons, Rochester, NY (US); Josh Simson, Rochester, NY (US); Christopher Coon, Rochester, NY (US)

(21) Appl. No.: 18/416,873

(22) Filed: Jan. 18, 2024

Related U.S. Application Data
(63) Continuation-in-part of application No. 17/325,100, filed on May 19, 2021.
(60) Provisional application No. 63/027,012, filed on May 19, 2020.

(51) Int. Cl. G06F 40/169; G06F 16/41; G06F 16/438; G06F 40/134; G06F 40/197

(52) U.S. Cl. CPC G06F 40/169; G06F 16/41; G06F 16/438; G06F 40/134; G06F 40/197

(57) ABSTRACT

A system and method for facilitating annotation of a digital document between first and second computing devices is provided. The system comprises a database/server that receives an original digital document from the first computing device and communicates a shared digital document to the second computing device. The second computing device receives and displays the shared digital document for annotation. The annotation produces an annotated digital document which includes annotated document data overlaying the original document without modification to the original document data. The original digital document may be edited at only the first computing device.

### CROSS-REFERENCE TO RELATED APPLICATIONS

This application is a continuation-in-part application of U.S. patent application Ser. No. 17/325,100, filed May 19, 2021, which claims the benefit of U.S. Patent Application No. 63/027,012, filed May 19, 2020, the entirety of each being hereby incorporated by reference.

### FIELD OF THE INVENTION

The present invention relates to a system which permits online collaborative annotation of digital content on any web-enabled device, and more particularly to a system which permits multiple users to annotate one or more digital files in real-time without modifying the underlying original digital content, and still more particularly to a system which permits multiple users to annotate more than one digital file while providing cross-referencing of annotations between all relevant digital content.

### BACKGROUND OF THE INVENTION

The traditional redline process which applies to many industries is that paper copies of a document are distributed to one or more people for review, comment and possible editing. In the field of controls engineering, panel drawings are printed out on paper and a technician will then use those prints to build the actual panel. During the build process, the technician may find mistakes within the current prints. The corrections for these mistakes are noted in red pen on the physical piece of paper. Once the panel is built, the technician delivers the redline drawings back to the design engineer so that the design engineer may update the drawings with the corrections included. Similar processes exist in the construction, real estate, legal, financial, educational and other markets. Such redline processes are time-consuming, inefficient and prone to errors.

Thus, there is a need for a web enabled application that allows for real-time collaboration of digital content on any web enabled device.

### SUMMARY OF THE INVENTION

The present invention provides, in a first aspect, a system comprising a software program operable to allow annotation of digital content which is accessed on a computer or other web-enabled device such as a smart phone, tablet or personal computer (PC), for example. Multiple parties may simultaneously access the digital content and provide annotations in real-time.

The program allows users to annotate any digital content which has been uploaded to a web location only accessible by designated individuals (“permitted users” accessing the digital content using appropriate security protocols such as passwords, for example). The annotations may include notes and questions to other permitted users, for example. In a preferred embodiment, the annotations are easily added to the displayed digital content using a “drag and drop” function. The notes may be listed in a log appearing in a column to the side of the digital content such that all permitted users can view any of the posted notes by clicking on the desired note log. Permitted users can add to any note or question as desired.

In a further aspect of the invention, a computer-implemented collaboration system is provided for facilitating annotation of an original digital file comprising original digital file data between a first computing device and a second computing device. The system comprises a database/server including a memory and a processor. The database/server is in communication with the first computing device and the second computing device over a network.

A first set of computer instructions, that when executed by the processor of the database/server, performs the steps of storing a shared digital file comprising shared digital file data, wherein the shared digital file data includes the original digital file data, and communicating the shared digital file data to the second computing device over the network.

A second set of computer instructions is configured for being stored in a respective memory of the first computing device and the second computing device. The second set of computer instructions is configured for being executed by a respective processor of the first computing device and the second computing device to perform the steps of receiving the shared digital file data from the database/server over the network, displaying the shared digital file data as the shared digital file on a respective display of the first computing device and the second computing device, allowing annotation of the shared digital file via a respective input device associated with the first computing device and the second computing device, wherein the annotation produces an annotated digital file which includes the shared digital file data and annotated digital file data wherein the annotated digital file data overlays the shared digital file without modification to the original digital file data, communicating the annotated digital file data to the database/server over the network, receiving, at the first computing device and the second computing device, the annotated digital file data from the database/server over the network, displaying the annotated digital file including each annotation of the plurality of annotations on the respective display of the first computing device and the second computing device; and allowing editing of the original digital file data at only the first computing device.

In yet another aspect of the invention, a computer-implemented digital file collaboration system comprises a database/server including a memory and a processor, and first and second sets of computer instructions. The database/server is in communication with each respective computing device of a plurality of computing devices over a network. The first set of computer instructions that when executed by the processor of the database/server performs the steps of storing a first shared digital file comprising first shared digital file data, wherein the first shared digital file data includes first original digital file data associated with a first original digital file, storing a second shared digital file comprising second shared digital file data, wherein the second shared digital file data includes second original digital file data associated with a second original digital file, and communicating the first shared digital file data and the second shared digital file data to each of the plurality of computing devices over the network.

The second set of computer instructions is configured for being stored in a respective memory of each of the plurality of computing devices. The second set of computer instructions is configured for being executed by a respective processor of each of the plurality of computing devices to perform the steps of receiving the first shared digital file data and the second shared digital file data from the database/server over the network, displaying one or both of the first and second shared digital file data as a respective first or second shared digital file on a respective display of each of the plurality of computing devices, allowing a first annotation of the first shared digital file via a respective input device associated with any of the plurality of computing devices, wherein the first annotation produces a first annotated digital file which includes the first shared digital file data and first annotated digital file data wherein the first annotated digital file data overlays the first shared digital file without modification to the first original digital file data, allowing a second annotation of the second shared digital file via a respective input device associated with any of the plurality of computing devices, wherein the second annotation produces a second annotated digital file which includes the second shared digital file data and second annotated digital file data wherein the second annotated digital file data overlays the second shared digital file without modification to the second original digital file data, and allowing cross-referencing of the first annotation with the second annotation wherein the first shared digital file includes a first hyperlink to the second shared digital file.

Additionally, the first hyperlink may be directed to a location of the second annotation within the second shared digital file. The second shared digital file may also include a second hyperlink to the first shared digital file. The second hyperlink may be directed to a location of the first annotation within the first shared digital file.

In a still further aspect of the present invention, a computer-implemented digital content collaboration system comprises a database/server including a memory and a processor, and first and second sets of computer instructions. The database/server is in communication with each respective computing device of a plurality of computing devices over a network. The first set of computer instructions that when executed by the processor of the database/server performs the steps of storing a first shared digital file comprising first shared digital file data, wherein the first shared digital file data includes first original digital file data associated with a first original digital file, storing a second shared digital file comprising second shared digital file data, wherein the second shared digital file data includes second original digital file data associated with a second original digital file, and communicating the first shared digital file data and the second shared digital file data to each of the plurality of computing devices over the network.

The second set of computer instructions is configured for being stored in a respective memory of each of the plurality of computing devices. The second set of computer instructions is configured for being executed by a respective processor of each of the plurality of computing devices to perform the steps of receiving the first shared digital file data and the second shared digital file data from the database/server over the network, displaying one or both of the first and second shared digital file data as a respective first or second shared digital file on a respective display of each of the plurality of computing devices, allowing a first annotation of the first shared digital file via a respective input device associated with any of the plurality of computing devices, wherein the first annotation produces a first annotated digital file which includes the first shared digital file data and first annotated digital file data wherein the first annotated digital file data overlays the first shared digital file without modification to the first original digital file data, allowing a second annotation of the second shared digital file via a respective input device associated with any of the plurality of computing devices, wherein the second annotation produces a second annotated digital file which includes the second shared digital file data and second annotated digital file data wherein the second annotated digital file data overlays the second shared digital file without modification to the second original digital file data, and generating a marker report including each of the first annotation and the second annotation.

The marker report further includes one or more of an identification of a respective shared digital file associated with each of the first annotation and the second annotation, an identification of a respective computing device of the plurality of computing devices which created each of the first annotation and the second annotation, an identification of a type of annotation of each of the first annotation and the second annotation, a reproduction of each respective annotation, and a status of each respective annotation.

Additional objects, advantages and novel aspects of the present invention will be set forth in part in the description which follows, and will in part become apparent to those in the practice of the invention, when considered with the attached figures.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1 is a screen shot showing an exemplary digital file undergoing real time collaboration by two permitted users;

FIG. 2 is a schematic drawing showing an exemplary system that may be used to implement any of the methods or processing described herein in accordance with one aspect of the present invention;

FIG. 3A is an exemplary screen shot of a user interface welcoming screen;

FIG. 3B is an exemplary screen shot of a user interface Get Started screen;

FIG. 4 is an exemplary screen shot of a user interface dashboard screen;

FIG. 5 is an exemplary screen shot of a user interface User Profile screen;

FIG. 6A is an exemplary screen shot of a user interface “Groups” screen;

FIG. 6B is an exemplary screen shot of a user interface “Groups” screen showing group members;

FIG. 7 is a schematic diagram of an exemplary system for group collaboration in accordance with an aspect of the invention;

FIG. 8 is a flow chart of an exemplary algorithmic sequence suitable for use with the exemplary system shown in FIG. 7;

FIG. 9 is a schematic diagram of an exemplary system for group collaboration using multiple, linked digital files in accordance with a further aspect of the invention;

FIGS. 10A-10J show partial screen shots of an exemplary algorithmic sequence for cross-linking annotations between two digital files in accordance with another aspect of the present invention;

FIG. 11A is a schematic of an example multiple member annotation of a group project comprising a plurality of digital files;

FIG. 11B is a partial screen shot of an exemplary user interface configured to generate a Marker Report for the example group project shown in FIG. 11A; and

FIG. 11C is an exemplary Marker Report for the example group project shown in FIG. 11A with the data displayed in table format.

### DETAILED DESCRIPTION OF A PREFERRED EMBODIMENT

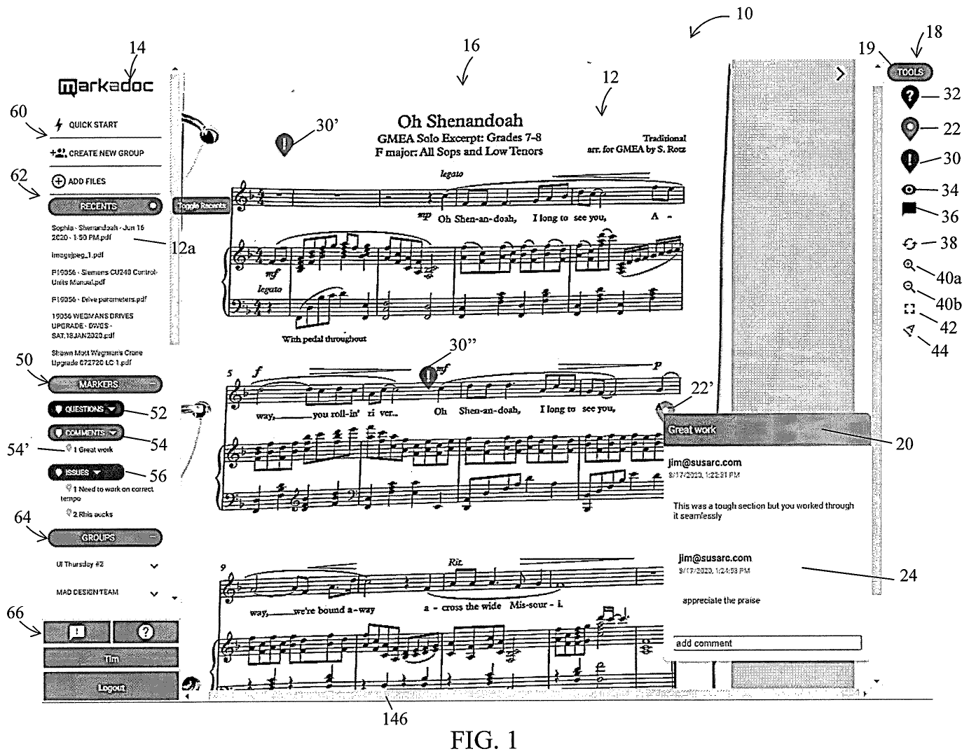

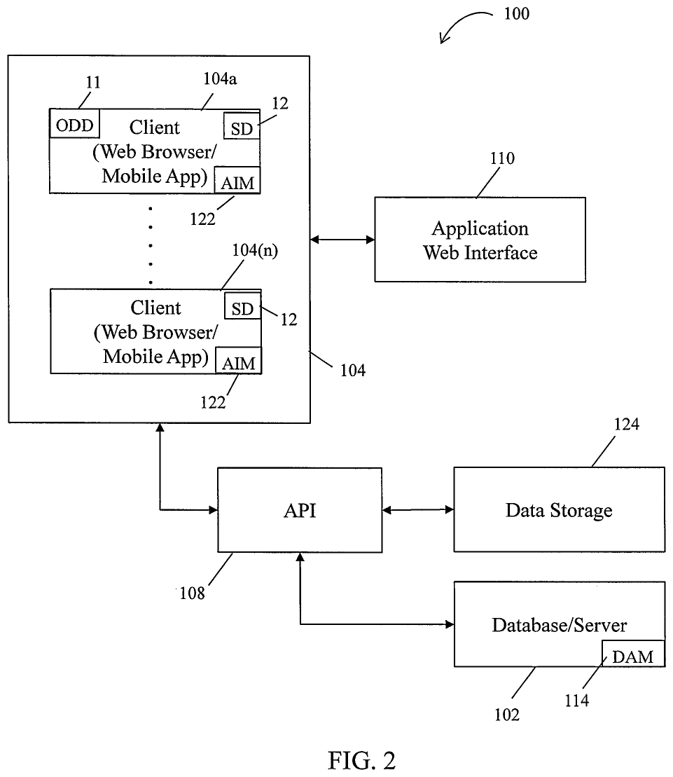

Referring to FIG. 1, the present invention provides an on-line collaboration system 10 operable to display a shared digital file 12 for group collaboration by permitted users who have been granted secure access to the secure internet site where system 10 is located. In one aspect, shared digital file 12 is a digital representation of an underlying original digital file 11 (see FIG. 2) and a reproduction of the digital file data comprising original digital file 11. In accordance with the present invention, the original digital file may include any digital content, such as but not limited to documents, photographs, videos, digital audio/music files, CAD renderings, 3D print files, and the like. The original digital file may also be saved under any available file format.

System 10 comprises a computer program which allows annotation of any commonly shared digital content such as shared digital file 12. For the sake of discussion, the original digital file 11 shown in FIG. 1 is a digital copy of sheet music for the song “Oh Shenandoah”, with shared digital file 12 being a digital document file having a .pdf file format. Any desired file type may be used (e.g., PDF, jpg, jpeg, tiff, etc.). The below description will also include references to document 12, but it should be understood by those skilled in the art that digital files 11 and 12 may be any suitable digital content, as stated above, and any reference to a document equally applies to such alternative digital content.

Returning now to FIG. 1, system 10 presents a user interface comprised of three columns, 14, 16, 18. Left-hand column 14 may be referred to as a “Navigation” column, while center column 16 is for shared document 12 display and right-hand column 18 contains “action items”, all of which will be described in greater detail below. It should be noted that one or two of columns 14, 16, 18 may be collapsed to a tab so as to provide additional display space for the remaining column(s). In the example provided in FIG. 1, shared document 12 is in pdf file format as seen at reference numeral 12a in left-hand Navigation column 14.

The system 10 allows annotation of shared document 12 easily and without requiring any electronic drawing features in the computer application. The application instead uses “drag-and-drop” functionality to create virtual “sticky notes” on the displayed document 12, such as via action items or “Tools” 19 from right-hand column 18. In the example provided in FIG. 1, a “Comment” 20 was created by selecting comment action item 22 from Tools 19, such as a tear-drop shaped flag containing a period “.” from right-hand column 18 and dragging (mouse click and hold; touch screen and hold) the flag to a desired location within shared document 12 and “dropping” (release mouse click; removing touch from screen) the flag 22′. A text window 24 then opens immediately adjacent flag 22′ so that the user providing the comment can add text therein. Text window 24 overlays shared document 12 and in no way modifies the underlying original document data of original digital document file 11. Users may then optionally save or print shared document 12 with all or some of annotations displayed on the document, as desired.

Other users may click “Comment” flag 22′ so as to open action window 24 to view the comment and add additional comments, if desired, in real-time. In one aspect of the invention, the location of the “Comment” flag 22′ is specifically selected by the original commenter whereby all users will understand that the comment made was directed toward the material located immediately adjacent to the flag. In another aspect of the present invention, the term “real-time” means having no more than 3-5 second delay between any addition and its subsequent display on each user's computing device, and more preferably to being nearly instantaneous (less than 1 second). As described above, none of these comments modify the underlying original digital document 11 or its associated document data. In one aspect of the invention, only the originator, i.e., the individual who first uploads shared digital document 12, can modify or edit the original digital document 11.

Users may also identify any specific issues that they have with specific portions of shared document 12. For instance, as shown in FIG. 1, an “Issue” may be created by selecting issue action button 30 from Tools 19, such as a tear-drop shaped flag containing an exclamation point “!” from right-hand column 18. Again, an “Issue” may be located on shared document 12 via drag-and-drop using a mouse, touchpad or other input device. As shown in FIG. 1, a first issue flag 30′ has been located near the top of shared document 12, while a second issue flag 30″ is located near the center of center column 16. A user selecting either issue flag 30′, 30″ will open a respective text window similar to text window 24 described above. The action window will present the text associated with the issue, as well as provide a text bar for further discussion amongst the users.

Additional functionalities offered by Tools 19 may include, but are not limited to, a “Question” flag 32, such as a tear-drop shaped flag containing a question mark “?” configured for drag-and-drop functionality similar to comment and issue flags 22, 30; a “Toggle markers” icon 34 which allows users to selectively view or hide all flags 22, 30, 32 displayed on shared document 12; a “Toggle text” icon 36 which allows users to selectively view of hide text windows 24 in center column 16; a “Refresh” icon 38 which allows the user to reload shared document 12; “Zoom” icons 40a, 40b which allow a user to zoom in 40a or out 40b the image shown in center column 16; a “Full Screen” icon 42 allowing the user to display center column 16 without left-hand or right-hand columns 14, 18; and a “Rotate image” icon 44 allows the user to rotate the image displayed in center column 16.

Each time a flag 22, 30, 32 is placed within the digital file (e.g., shared document 12) displayed within center column 16, a quick link is added under the Markers tab 50 within left-hand Navigation column 14. In one aspect of the invention, Markers tab 50 may function as a drop-down list which is further delineated into respective Questions, Comments and Issues sub-tabs 52, 54, 56, with each sub-tab comprising its own drop-down list populated with a numbered link and abridged text corresponding to each respective flag 22, 30, 32. In this manner, a user may select one class of flags to review and locate a specific flag within the digital file by clicking on the desired hyperlink under the selected sub-tab 52, 54, 56.

By way of example and without limitation thereto, as shown in FIG. 1, Comments sub-tab 54 may include a numbered link 54′, such as “1 Great work”, which corresponds to Comments flag 22′ described above. A user may wish to review this comment. Clicking on the link 54′ will direct the user to the specific flag 22′, and thus the specific location within the digital file (e.g., shared document 12) shown in center column 16, and open the appropriate text window 24. This allows for quick filtering and searching for particular annotations while also allowing other users to add additional comments to the flag, all in real-time.

The system 10 thus provides ability to drag-and-drop an annotation, add comments and save them on a shared document. As all such annotations are electronically “layered onto” the display of shared document 12, the original document 11 itself remains unchanged. The original document 11 may then be edited by the originator taking all of the comments, notes and/or questions into consideration before finalizing the finished document. As a result, multiple copies of the document in various states of editing may be avoided, thus improving efficiencies while minimizing errors.

In accordance with a further aspect of the invention and as will be described in greater detail below, left-hand Navigation column 14 provides additional quick link functionalities, such as but not limited to Group Creator 60, Document Navigator 62, Group Navigator 64, as well as User Services 66.

With reference to FIG. 2, the system, tools and methods described herein for facilitating annotation of a digital document may be implemented in hardware, software, and combinations thereof. Reference numeral 100 generally designates an exemplary network environment in which a computer-implemented document annotation system in accordance with one aspect of the invention may be implemented. System 100 utilizes one or more computing devices to facilitate the exchange of information between each computing device and a central database/server via an application programming interface (API) so as to enable real-time annotation of shared digital document 12 across the network while original document 11 may remain isolated to the originator's computing device (e.g., computing device 104a described below). While the discussion herein refers specifically to a document annotation system, it should be understood that the system may be used in conjunction with other types of digital files, such as photographs, and/or editing functionalities.

For instance, system 100 may include a database/server 102 and any number of client computing devices 104, e.g., computing devices 104a-104(n), in communication with each other over a network via API 108. The network may be any type of network, such as a wide area network or local area network that allows for wired and/or wireless communication between database/server 102 client computing devices 104 and API 108. It should be understood that computing devices 104 may be a desktop computer, smartphone, tablet, or any other type of mobile computing device that includes a processor configured for implementing computer-executable instructions and methods as described herein. Computing devices 104 are web-enabled devices utilizing application web interface 110 as described in greater detail below.

In accordance with an aspect of the present invention, database/server 102 includes a processor and a memory having a document annotation module 114 stored therein. Document annotation module 114 includes a first set of computer-executable instructions configured for performing, through the use of the processor, a number of algorithmic steps that facilitate the document annotation process described herein. In particular, document annotation module 114 may be a cloud-based software platform that is accessible by computing devices 104 via application web interface 110.

First computing device 104a utilizes document annotation module 114 to, among other things, allow for the communication of the document data comprising original digital document 11 from first computing device (originator) 104a to a data store/memory 124 so that shared digital document 12 can be annotated by annotator interface module 122 resident on each computing device 104. Annotator interface module 122 may include a set of computer-executable instructions stored in a memory of each computing device 104 and be configured for annotating the document data of original digital document 11 to produce annotated document data within annotated digital document 12 to be stored within data store/memory 124. The annotated digital document data may then be communicated to each computing device 104 in real-time to produce updated annotated digital documents for all group members having access to the annotated digital document.

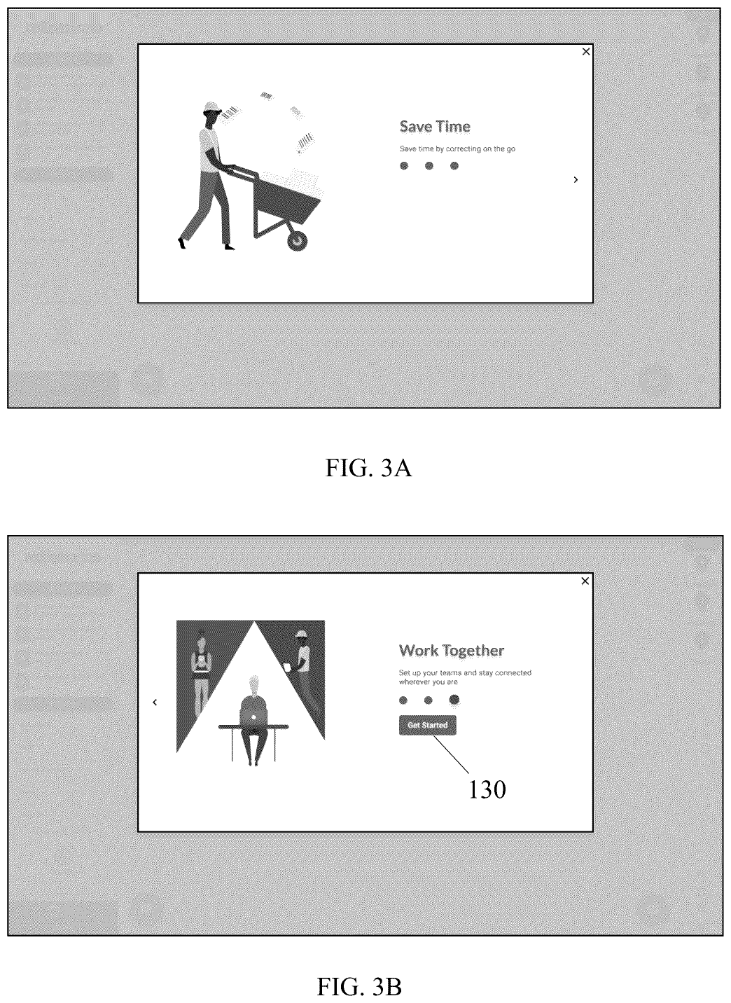

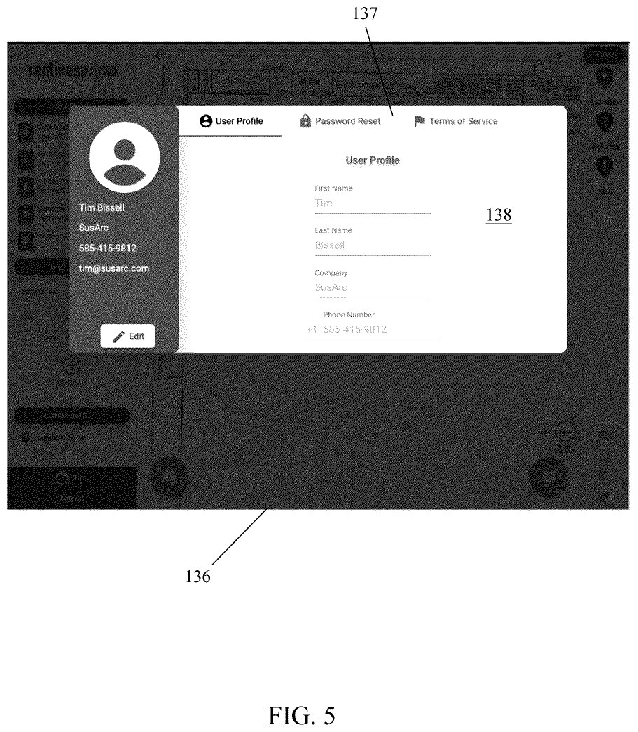

Annotator interface module 122 may be in the form of a software application (i.e., mobile app) or any other type of software program that can be easily downloaded and used to interact with computing devices 104. A series of exemplary screen shots are provided in FIGS. 3A-6B illustrating the functionality that may be provided by annotator interface module 122.

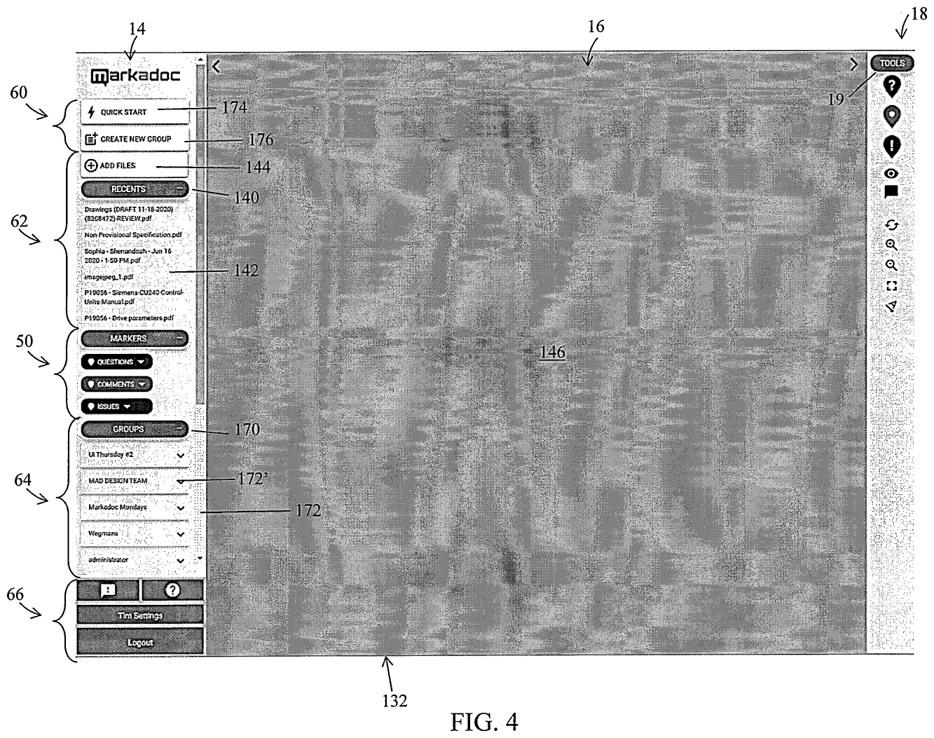

As seen in FIGS. 3A and 3B, annotator interface module 122 provides a welcome screen (FIG. 3A) as well as a start-up screen (FIG. 3B). Clicking, tapping or otherwise activating the “Get Started” action box 130 operates to open the dashboard 132 shown in FIG. 4. Dashboard 132 serves as the hub for additional interface functionalities.

Returning to FIG. 4, with proper login credentials entered, a user may then access any authorized documents for annotation through Document Navigator 62. Document Navigator 62 may include a “Recents” tab 140 which presents a drop-down list 142 of recently view files. Should a different document be desired, the user may search for the document through the Group Navigator 64, described below. Once a document is selected, a current copy of the annotated digital document 12, along with any annotations/flags 20, 30, 32, is displayed in document window 146 (center column 16) (see FIG. 1). A user may also upload a file to a group using the “Add files” link 144 within Group Creator 60, as will be described below.

In accordance with an aspect of the present invention, document management may further utilize Group Navigator 64 which includes a system of defined “Groups” 170 such that related documents can be grouped together in common folders 172 whereby only specified documents can be accessed and annotated by authorized members of the group. Only those groups for which a user has been granted access are displayed in Groups 170. Activating a specific folder 172′ presents a drop-down list of documents available for viewing and annotation.

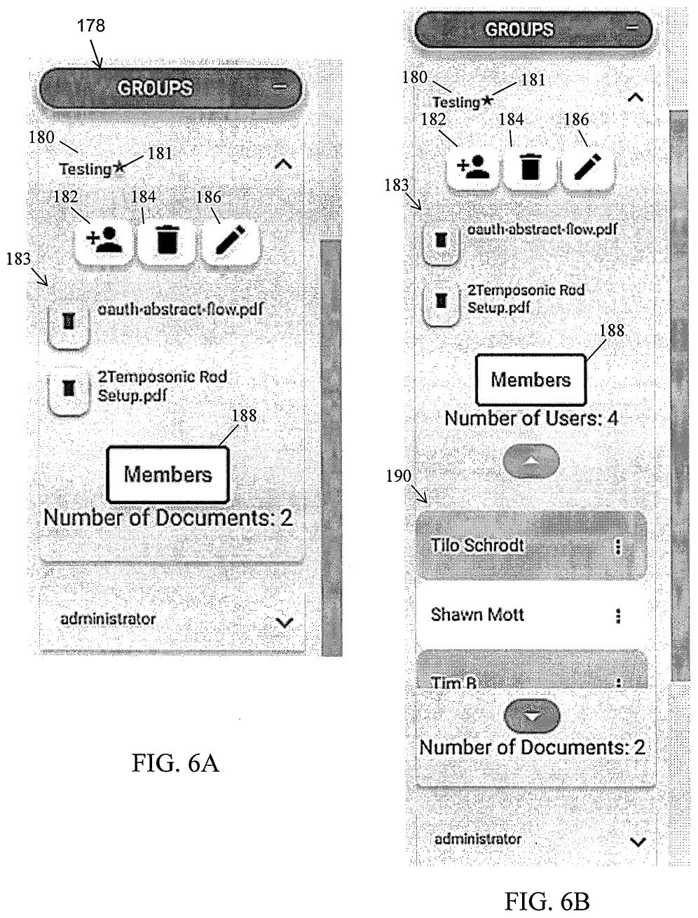

With continued reference to FIG. 4, group creation may be initiated using Group Creator 60 where a user may utilize “Quick Start” 174 to open a file having a pre-selected group member profile, or may initiate creation of a new group by clicking “Create New Group” 176 which will open a file with no pre-selected group members. With additional reference to FIGS. 6A and 6B, group creation and member allocations can be accessed by activating the Group Navigator 64 of dashboard 132 (FIG. 4). Activating Group Navigator 64 will present a drop-down list of all groups that the user has created or been granted access. Groups created by the user may be specially designated, such as via an asterisk, star or other indicia signifying that the creator also operates as the “administrator” of those groups.

As administrator, the user can open a pop-up window 178 such as that shown in FIG. 6A. As shown in FIG. 6A, the Group has been identified as “Testing” 180 and includes indicia 181 designated the user as administrator as well as a list of file(s) 183 added during creation of the group. A series of action boxes 182, 184, 186 and 188 become active. Action box 182 allows the administrator to add new, authorized members to the group. Action box 184 is used to delete the group while action box 186 allows the administrator to rename the group. As shown in FIG. 6B, activation of action box 188 labeled “Members” opens a drop-down list of all members 190 currently assigned to the group. Authorized members can then access the documents located within Group Navigator 64 for annotation, as described above.

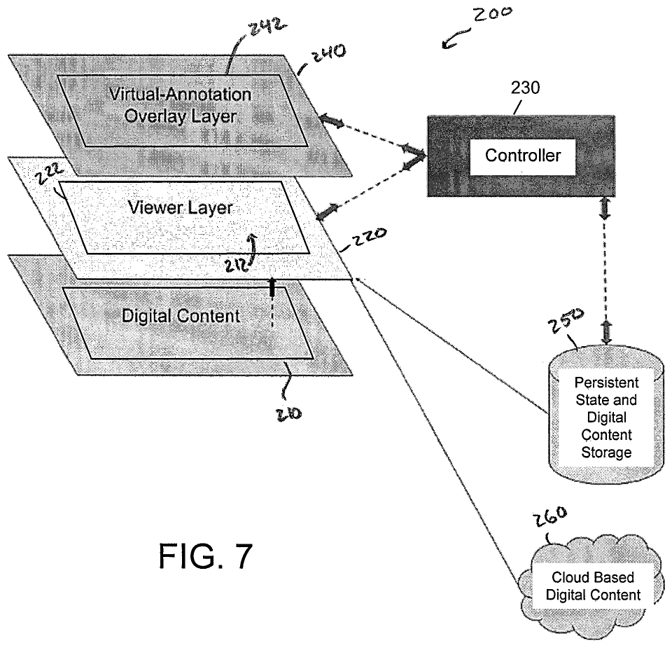

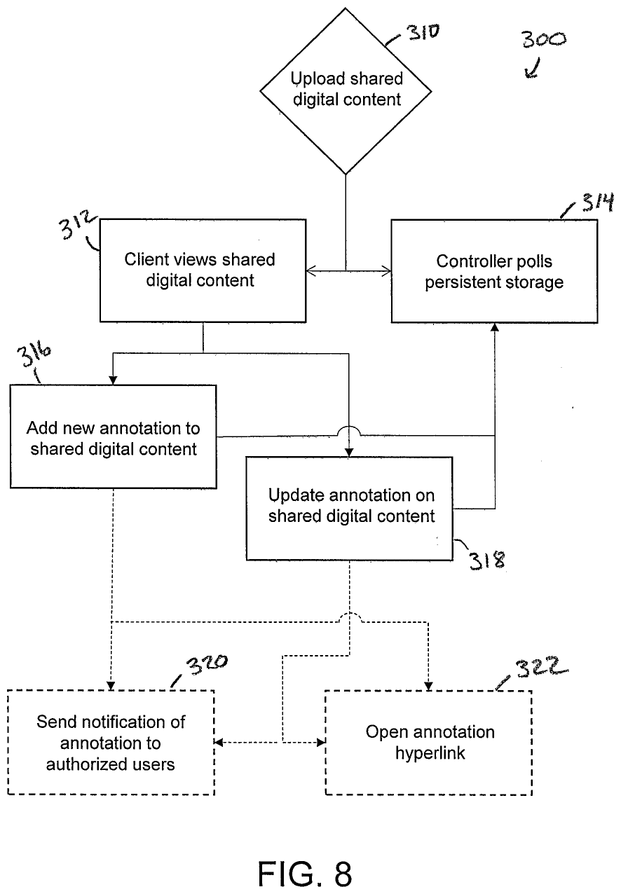

Turning now to FIGS. 7 and 8, an exemplary system 200 and exemplary algorithm 300, respectively, suitable for carrying out the above actions, are presented. As shown in FIG. 8, exemplary system 200 includes digital content 210, such as but not limited to digital file 11 described above, e.g., documents, photographs, videos, digital audio/music files, CAD renderings, 3D print files, and the like. Digital content 210 is then reproduced and presented within viewer layer 220 may be represented by a user interface (UI) 222 whereby the underlying digital content 210 remains immutable throughout collaborative operations as described above and as will be described in greater detail below.

Viewer layer 220 informs controller 230 of the current view of the shared digital content 212, e.g., shared digital file 12 and any annotations, i.e., flags 22, 30, 32, displayed on shared document 12 (see FIG. 1). Viewer layer 220 further reacts to controller 230 commands, such as those input through virtual-annotation layer 240 as will be described further with regard to exemplary algorithm 300 shown in FIG. 8. In one aspect of the invention, virtual-annotation layer 240 may be represented by a user interface (UI) 242 that is presented though a web browser, or a desktop/laptop/mobile/tablet computing application (the “Annotation App”). As described above, virtual-annotation layer 240 may include static content for under content navigation and for the selection and creation of virtual annotations.

In one aspect of the invention, controller 230 manipulates viewer layer 220 to display virtual annotations input via virtual-annotation layer 240 at the correct x, y and z coordinates. By way of example and without limitation, the x and y coordinates may include positional data within the two dimensional (2D) digital image shown in viewer layer 220 and virtual-annotation layer 240. The z coordinate may be any additional data, such as but not limited to, positional data such as within a 3D CAD file or 3D print file, or temporal (time) data within a digital audio and/or video file.

With reference to FIG. 8, exemplary algorithm 300 begins at step 310 when an owner uploads a shared copy (e.g., shared digital content 212) of the original digital content (digital content 210) to the viewer layer 220. See FIG. 7. At step 312, a user/client (e.g., computing device 104) interacts with system 200 via virtual-annotation layer 240 to view shared digital content 212 and any annotations overlaying the shared digital content 212. Controller 230 may also poll persistent storage 250, such as data storage 124, to retrieve shared digital content 212 and any annotations overlaying the shared digital content 212 for presentation on virtual-annotation layer 240 at step 314.

Computing device 104 may interact with virtual-annotation layer UI 242, such as via an appropriate input device including but not limited to a mouse, touch pad, touch screen, and the like. Computing device 104 may select a portion of the shared digital content 212 to view, thereby causing controller 230 to signal to viewer layer 220 to scroll content, find, or switch sections of shared digital content 212 being presented. Controller 230, in combination with integration with viewer layer 220, keeps the virtual annotation overly content shown in virtual-annotation layer UI 242 synchronized with the viewer presentation of the corresponding section of the shared digital content 212 shown in viewer layer UI 222.

With continued reference to FIG. 8, at step 316, computing device 104 may interact with virtual-annotation layer UI 242 to add virtual annotations through one or more inputs such as mouse clicks, touch, drag-and-drop, and similar operations, and combinations thereof. The controller persists each added virtual annotation within storage 250 such that other computing devices 104 may access the virtual annotation via virtual-annotation layer 240 and virtual-annotation layer UI 242 as described above. As step 318, any authorized computing device 104 (e.g., one or more of computing devices 104a-104(n)) may interact with its respective virtual-annotation layer UI 242 to select and update any pre-existing virtual annotation (such as an annotation input in step 316) that are presented by controller 230 after polling storage 250 (e.g. step 314) and updating virtual-annotation layer 240 and virtual-annotation layer UI 242. Any updated virtual annotations may be made through one or more inputs such as mouse clicks, touch, drag-and-drop, and similar operations, and combinations thereof operably coupled to the respective computing device 104.

At optional step 320, controller 230 send a respective notification to each authorized computing device 104 notifying each authorized computing device 104 that an annotation has been added (step 316) or updated (step 318). The notification may be through one or more of any suitable electronic communication, such as but not limited to an email, text, push notification, and the like.

At optional step 322, if an authorized computing device 104 selects a virtual annotation including a hyperlink, controller 230 signals viewer layer 220 to open and present the appropriate selected digital content that was link, along with the corresponding virtual annotation, on virtual-annotation layer 240 and virtual-annotation layer UI 242. As will be described in greater detail below, if the hyperlink leads to a URL (Uniform Resource Locater) hyperlink external to the Annotation App, the hyperlink may be opened in an associated external window/display/app, such as a web browser.

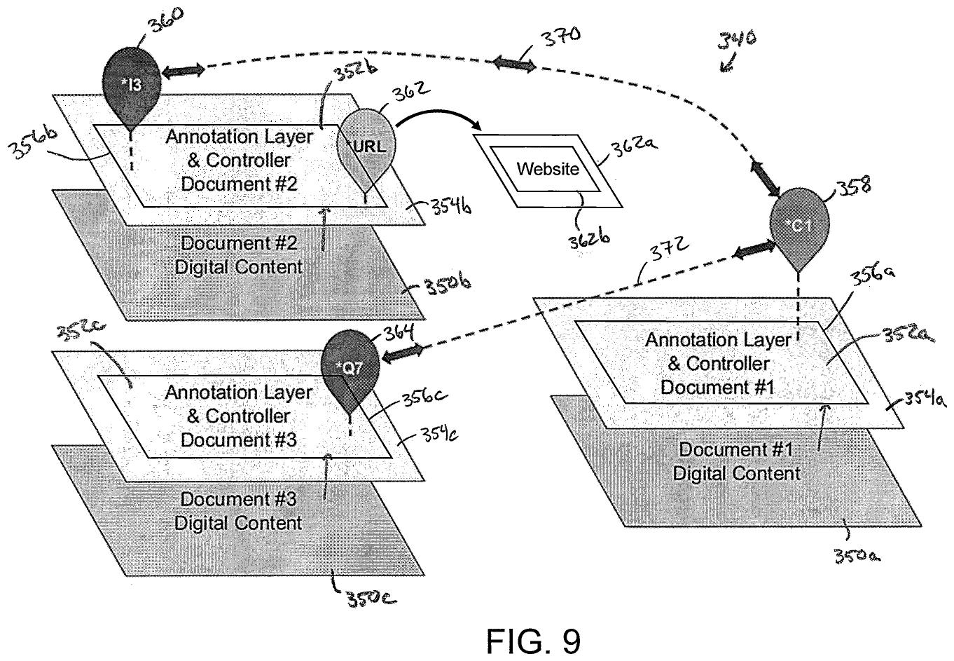

With reference to FIG. 9, a generalized system 340 for crosslinking annotations across two or more digital files containing respective digital content 350a, 350b, 350c. While shown and described below as “documents”, it should be noted that each respective digital content 350a, 350b, 350c may comprise any one or more digital files having any suitable digital file format, including but not limited to documents, photographs, videos, digital audio/music files, CAD renderings, 3D print files, and the like. It should be further noted that each respective digital content 350a, 350b, 350c may comprise the same as or different digital file formats. Still further, each respective digital content 350a, 350b, 350c may be resident on the same computing device 104 or each respective digital content 350a, 350b, 350c separate computing devices (e.g. 104a, 104b, 104c, 104(n)).

As described above, each respective digital content 350a, 350b, 350c is uploaded to a respective viewer layer as respective shared digital content 352a, 352b, 352c which is then saved in storage 250 where it is polled by controller 230 for presentation in a respective virtual-annotation layer 354a, 354b, 354c having a respective user interface (UI) 356a, 356b, 356c. (Note that each of the viewer layers (e.g., viewer layer 220, FIG. 7) has been omitted for simplicity of FIG. 9 and improved clarity of the description thereof).

As can be seen in FIG. 9, virtual-annotation layer 354a and UI 356a include a first annotation 358 represented as comment C1; virtual-annotation layer 354b and UI 356b include second and third annotations 360, 362 represented respectively as issue I3 and an external hyperlink URL; and virtual-annotation layer 354c and UI 356c include a fourth annotation 364 represented as question Q7. Each annotation 358, 360, 362, and 364 contains respective data including, but not limited to, the digital content identification, page number (if applicable), and x, y, and z coordinate data. Each annotation 358, 360, 362, and 364 may also be extendable to include hyperlinks to other digital files, annotations in other digital files, and/or external hyperlinks (i.e., third annotation 362—URL, which when selected as described above, may open a new external window/display/app 362a, such as a web browser 362b).

By way of example and without limitation thereto, the exemplary system 340 may have first annotation 358 (C1) on virtual-annotation layer 354a/UI 356a crosslinked with second annotation 360 (I3) on virtual-annotation layer 354b/UI 356b, as well as with fourth annotation 364 (Q7) on virtual-annotation layer 354c/UI 356c. When link 370 from first annotation 358 (C1) to second annotation 360 (I3) is executed, controller 230 signals storage 250 to open shared digital content 352b at the page (if applicable) and x, y, and z coordinate data for second annotation 360 (I3).

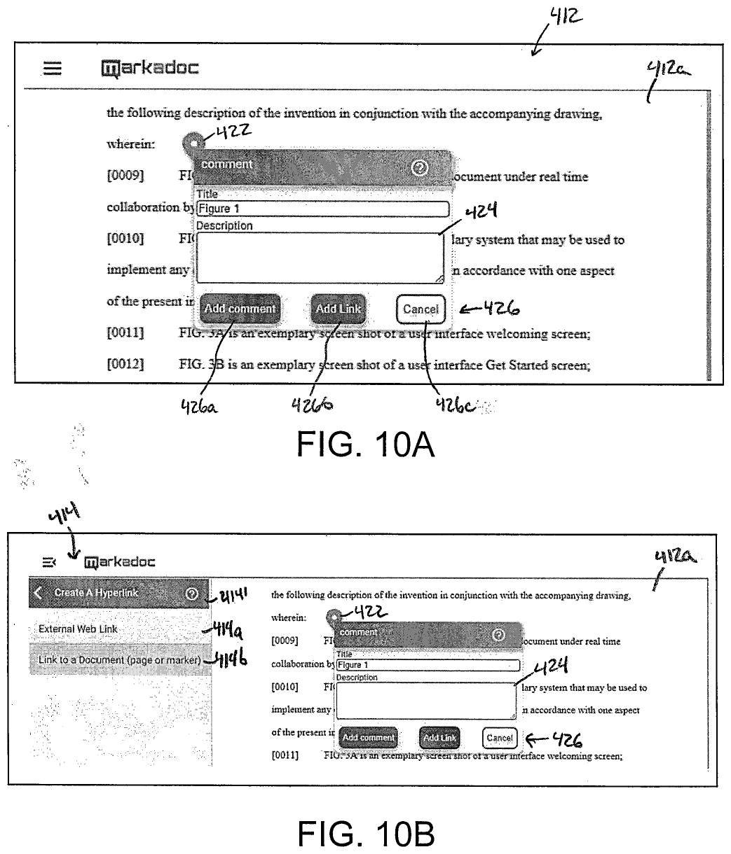

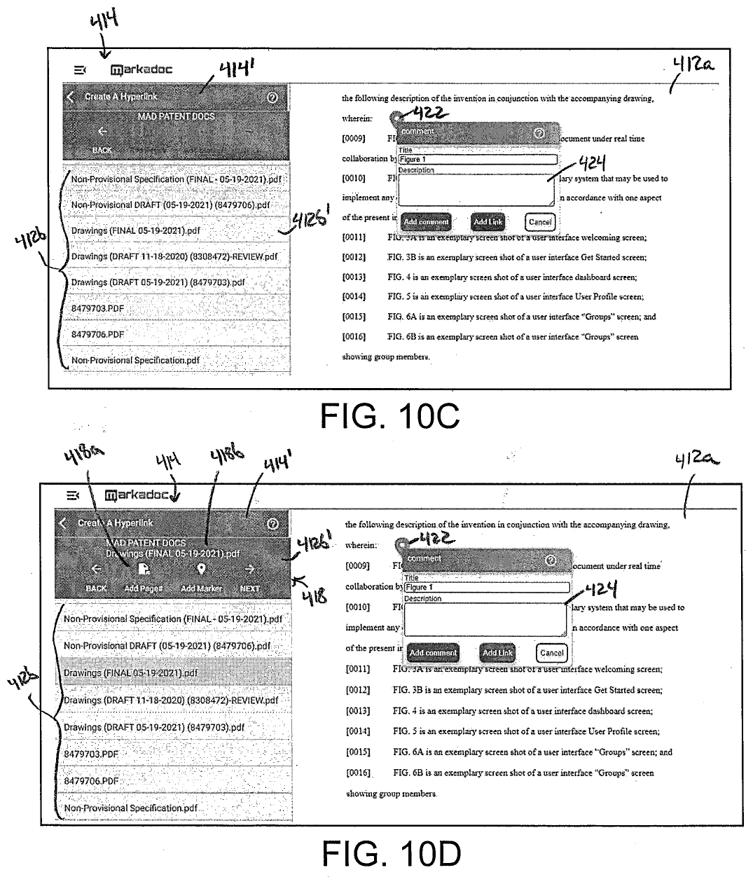

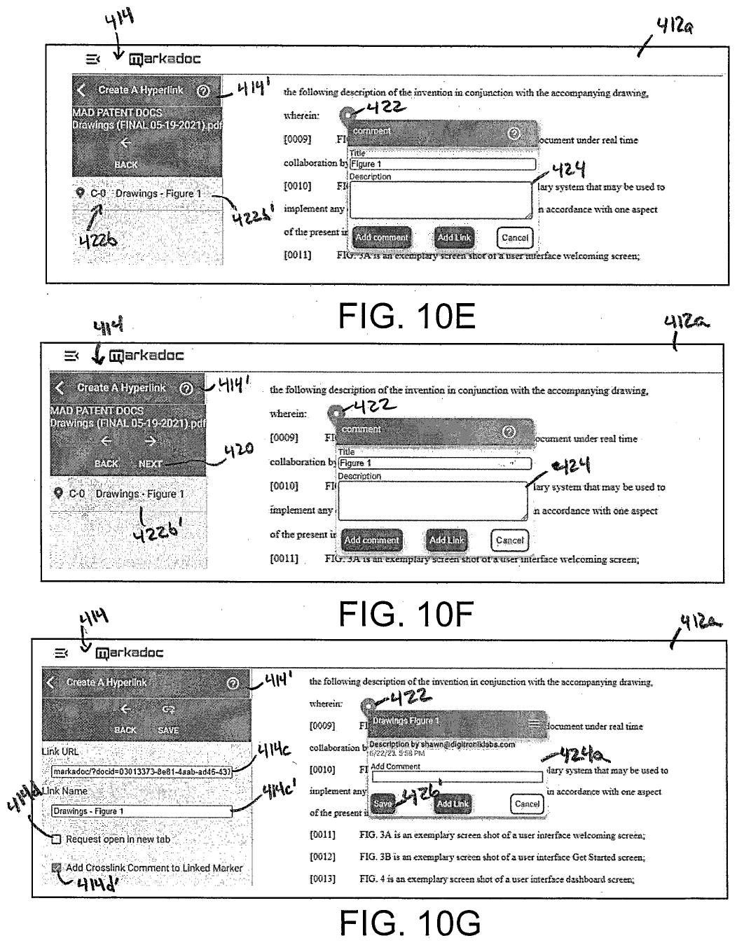

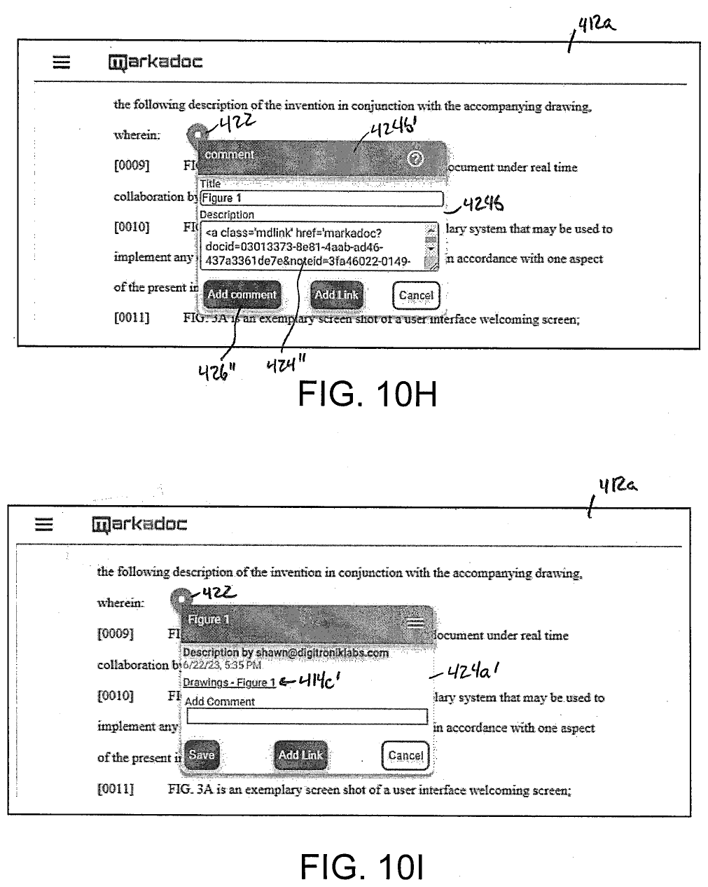

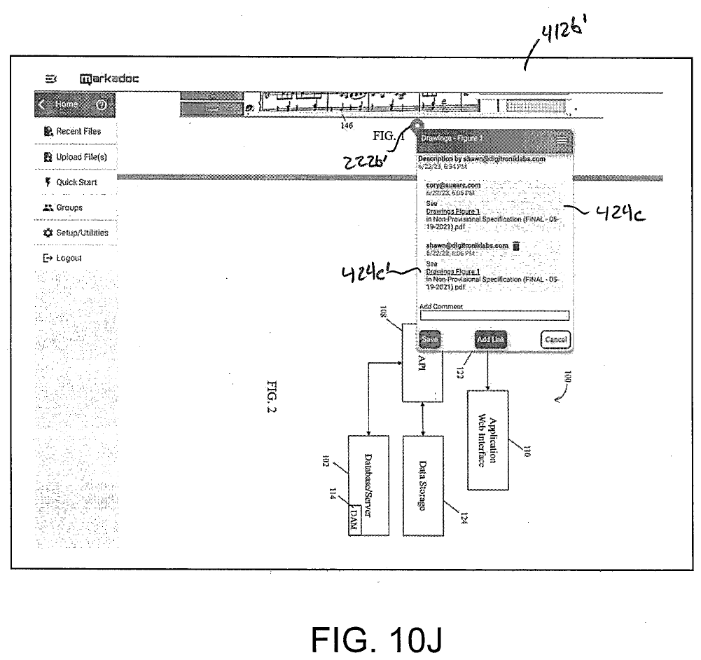

In a further aspect, as will be described in greater detail below, an annotation dialog box (see e.g., text box 424, FIG. 10A, and discussion thereof) may also be opened so that the user can see/read the discussion concerning issue I3 which is the subject of second annotation 360. Execution of link 370 via second annotation 360 (I3) signals controller 230 to poll storage 250 and open virtual-annotation layer 354a/UI 356a at the location of first annotation 358 (C1). Similar operability is afforded by link 372 between first annotation 358 (C1) on virtual-annotation layer 354a/UI 356a and fourth annotation 364 (Q7) on virtual-annotation layer 354c/UI 356c.

Thus, a user may efficiently review multiple issues/comments/questions within multiple digital content files without having to open and search respective file folders and the digital files contained therein. Providing links (e.g., links 370, 372) allows for the quick and easy interchange between specified digital files and content locations therein for effective group collaboration.

Turning now to FIGS. 10A-10J, in a further embodiment of the present invention, on-line collaboration system 10 may also allow for group collaboration and cross-referencing of flags 20, 30, 32 (see e.g., FIG. 1) across two or more digital files 412a, 412b, 412(n). Again, for the sake of discussion and without limitation thereto, digital files 412 (412a, 412b, 412c) (and their underlying digital data) will be referred to as “documents” or “document data” although those skilled in the art should recognize that any suitable digital file/file format may be equally substituted, including, without limitation, photographs, videos, digital audio/music files, CAD renderings, 3D print files, and the like. In one aspect, each of digital files 412 are shared digital files uploaded to database/server 102 and accessible (if authorized) by computing devices 104 as described above (see FIG. 2). It should be further noted that each respective shared digital file 412 may have the same or a different originator such that the respective original digital data for each original digital file may be stored on more than one computing device 104.

As shown in FIG. 10A, a user creates a new flag or selects an existing flag 22, 30, 32 (e.g., comment flag 422 within shared document 412a within window 416) which results in the opening of a text box 424. Text box 424 may include one or more action buttons 426, for instance and without limitation thereto, an “Add Comment” button 426a, “Add Link” button 426b or “Cancel” button 426c. Selection of the “Add Link” button 426b refreshes left-hand “Navigation” column 414 to display a “Create a Hyperlink” drop-down menu 414′ including additional action buttons, such as but not limited to buttons 414a, 414b. By way of example, button 414a may allow the user to input a hyperlink to an internet website within “Description” window 424a of text box 424.

Alternatively, as shown in FIG. 10C, selection of button 414b refreshes the “Create a Hyperlink” drop-down menu 414′ for shared document 412a so as to list a series of shared documents 412b available for cross-referencing thereto. FIG. 10D shows the selection of an exemplary shared document 412b′ (see also FIG. 10C) along with a number of action buttons 418 including an “Add Page #” button 418a which allows the user to add a cross-referencing link to the designated page within shared document 412b′ and “Add Marker” button 418b which allows the user to add a cross-referencing link to a designated flag or marker within shared document 412b′ as will described in greater detail below.

As shown in FIG. 10E, the “Add Marker” button 418b within FIG. 10D has been selected by the user such that the “Create a Hyperlink” drop-down menu 414′ refreshes to provide a list the markers 422b within shared document 412b′ to which the cross-referencing link may be paired (in the example shown, only one marker 422b′ is listed). Following selection of the marker 422b′, the “Create a Hyperlink” drop-down menu 414′ is refreshed whereby the user can confirm placement of the link by selecting the “Next” action button 420, as seen in FIG. 10F.

In FIG. 10G, a confirmation dialog box 424a is displayed on shared document 412a providing a “Save” action button 426′ to confirm setting of the link. The “Create a Hyperlink” drop-down menu 414′ is refreshed to provide the Link URL 414c and Link Name 414c′. Check boxes 414d and 414d′ may provide additional operations, such as “Request open in new tab” box 414d and “Add Crosslink to Linked Marker” box 414d′ which will be discussed in greater detail below.

After selecting the “Save” button in FIG. 10G, a dialog box 424b opens on shared document 412a providing comment text box 424b′ with hyperlink 424b″ as shown in FIG. 10H. Selecting the “Add comment” action button 426″ finalizes the addition of the hyperlink within dialog box 424b′ associated with marker 422b′. The hyperlink may then be replaced by an underlined Link Name 414c′ in comment text box 424a′ (FIG. 10I) which, when activated, redirects the user to the location of the hyperlink within shared document 412b′ (FIG. 10J). If the “Add Crosslink Comment to Linked Marker” box 414d′ is checked on shared document 412a (FIG. 10G), a cross-referencing hyperlink 424c′ is included within comment box 424c in shared document 412b′ and is directed toward comment flag 422b′ within shared document 412b′ (FIG. 10J).

Thus, in view of the above, in one exemplary embodiment of the present invention, a computer-implemented document collaboration system comprises a database/server including a memory and a processor, and first and second sets of computer instructions. The database/server is in communication with each respective computing device of a plurality of computing devices over a network. The first set of computer instructions that when executed by the processor of the database/server performs the steps of storing a first shared digital document comprising first shared digital document data, wherein the first shared digital document data includes first original digital document data associated with a first original digital document, storing a second shared digital document comprising second shared digital document data, wherein the second shared digital document data includes second original digital document data associated with a second original digital document, and communicating the first shared digital document data and the second shared digital document data to each of the plurality of computing devices over the network.

The second set of computer instructions is configured for being stored in a respective memory of each of the plurality of computing devices. The second set of computer instructions is configured for being executed by a respective processor of each of the plurality of computing devices to perform the steps of receiving the first shared digital document data and the second shared digital document data from the database/server over the network, displaying one or both of the first and second shared digital document data as a respective first or second shared digital document on a respective display of each of the plurality of computing devices, allowing a first annotation of the first shared digital document via a respective input device associated with any of the plurality of computing devices, wherein the first annotation produces a first annotated digital document which includes the first shared digital document data and first annotated digital document data wherein the first annotated digital document data overlays the first shared digital document without modification to the first original document data, allowing a second annotation of the second shared digital document via a respective input device associated with any of the plurality of computing devices, wherein the second annotation produces a second annotated digital document which includes the second shared digital document data and second annotated digital document data wherein the second annotated digital document data overlays the second shared digital document without modification to the second original document data, and allowing cross-referencing of the first annotation with the second annotation wherein the first shared digital document includes a first hyperlink to the second shared digital document.

Additionally, the first hyperlink may be directed to a location of the second annotation within the second shared digital document. The second shared digital document may also include a second hyperlink to the first shared digital document. The second hyperlink may be directed to a location of the first annotation within the first shared digital document.

From the above it can be seen that the present invention may allow all users to directly link between documents of interest within a group of collaborative documents. Thus, there is no longer a need to close a first document, search for the reference second document, load the second document and then review the second document to find the annotation referenced in the first document. In other words, once a plurality of annotations with any number of documents have been linked and cross-referenced, a user can navigate the documents, via the cross-linked annotations in an N-dimensional database.

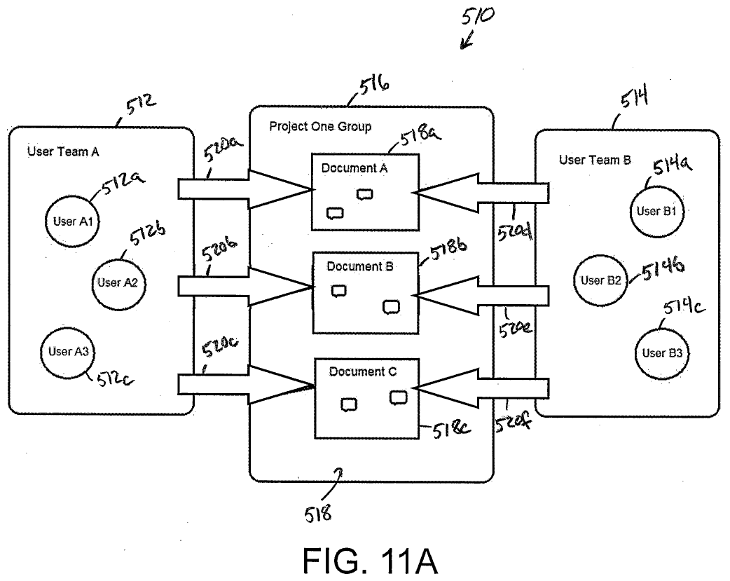

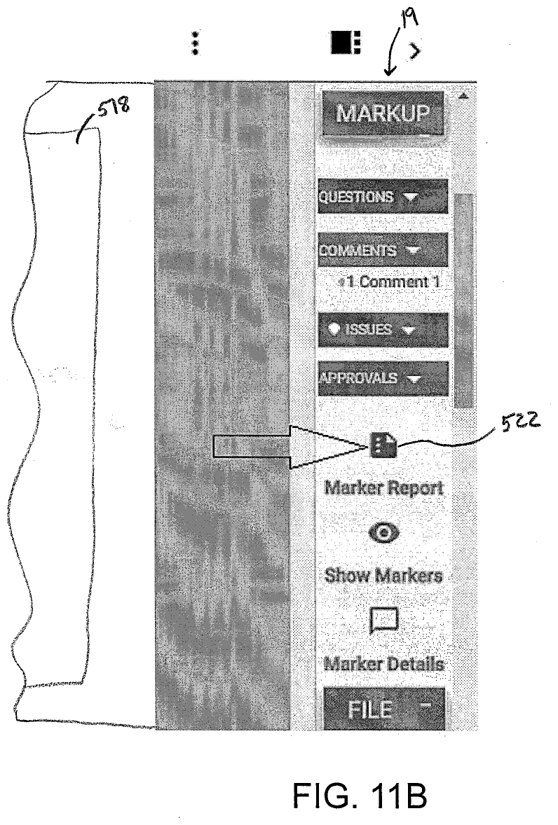

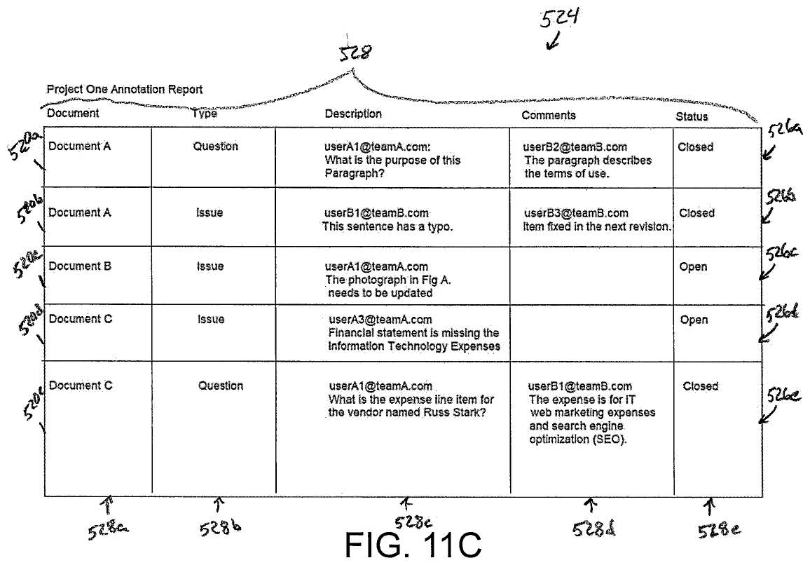

Turning now to FIGS. 11A-11C, in accordance with another aspect of the present invention, on-line document collaboration system 10 may monitor and track all annotations to one or more documents which may then be compiled and displayed in a marker report. By way of example and without limitation thereto, FIG. 11A is a schematic diagram of an exemplary collaboration 510 between User Team “A” 512 and User Team “B” 514. Team “A” may comprise one or more team members 512, e.g., members 512a, 512b and 512c; while Team “B” may comprise one or more team members 514, e.g., members 514a, 514b and 514c, with Teams A and B jointly working on a Group Project 516 which includes a plurality of documents uploaded to database/server 102 as shared documents 518, e.g., shared document 518a, shared document 518b, shared document 518c, as described above with regard to shared document 12, 412.

Each team member 512a, 512b, 512c, 514a, 514b and 514c may make annotations, e.g. annotations 520a, 520b, 520c, 520d, 520e and 520f, to any, all or none of shared documents 518 as discussed above with regard to FIG. 1 or FIGS. 10A-10H. That is, each annotation will be designated by a respective flag (marker) within the corresponding marked shared document 518. Database/server 102 may maintain a digital record of each annotation and the team member responsible for creating each respective annotation. With reference to FIG. 11B, any team member 512a, 512b, 512c, 514a, 514b, 514c may then generate a Marker Report, such as via actuating a “Marker Report” action button 522 on any shared document 518. In one aspect of the invention, “Marker Report” action button 522 may be located in right-hand column 18 under the “Tools” 19 heading.

Turning now to FIG. 11C, an exemplary Marker Report 524 is shown. Marker Report 524 may be loaded within shared document 518 or in a new window. By way of example and without limitation, Marker Report 524 may be shown in table format with each annotation delegated to a respective horizontal row 526 (e.g., five annotations would be delegated to respective rows 526a-526e) within table 524a. Each annotation may then be dissected into any number of subcategories with each subcategory being tabulated within a respective vertical column 528.

Again, without limitation thereto, sample Marker Report 524 provides a table 524a with five columns 528a-528e. By way of example, first column 528a may list the respective shared document 518 where the respective annotation 520 (e.g., annotation 520a-520e) is located; second column 528b may list the type of annotation (e.g., flag/marker) added (e.g., comment 22, 422, question 32 or issue 30) while third column 528c may reproduce the initial annotation text that is contained within the corresponding text box 24, 424 associated with the respective annotation in shared document 518. Fourth column 528d may include any additional annotations text contained within the text box 24, 424 submitted by any team members 512a, 512b, 512c, 514a, 514b, 514c which addresses the initial annotation and subsequent discussion thereof. Fifth column 528e may then display marker status; such as but not limited to an open/closed status designated whether the initial comment 22, 422, question 32 or issue 30 has been resolved through the collaborative efforts of team members 512a, 512b, 512c, 514a, 514b, 514c.

It should be further noted that the respective annotations 520a-520e may be organized as desired by the user. For instance, as shown in exemplary Marker Report 524, annotations 520a-520e have been arranged by document, e.g. downwardly listing the documents in alphabetical order with Document A listed first. However, additional alternative listings may be selected by heading. By way of example and without limitation and with continued reference to table 524a, annotations 520a-520e may be listed by type, such as presenting the questions 520a, 520e first (e.g., rows 526a, 526b) followed by Issues 520b, 520c, 520d in rows 526c-526e, respectively; or by status whereby open annotations 520c and 520d may be presented first (e.g., rows 526a, 526b) followed by closed annotations 520a, 520b, 520e in rows 526c-526e, respectively.

Thus, in view of the above, an exemplary embodiment of the present invention is directed to a computer-implemented document collaboration system comprising a database/server including a memory and a processor, and first and second sets of computer instructions. The database/server is in communication with each respective computing device of a plurality of computing devices over a network. The first set of computer instructions that when executed by the processor of the database/server performs the steps of storing a first shared digital document comprising first shared digital document data, wherein the first shared digital document data includes first original digital document data associated with a first original digital document, storing a second shared digital document comprising second shared digital document data, wherein the second shared digital document data includes second original digital document data associated with a second original digital document, and communicating the first shared digital document data and the second shared digital document data to each of the plurality of computing devices over the network.

The second set of computer instructions is configured for being stored in a respective memory of each of the plurality of computing devices. The second set of computer instructions is configured for being executed by a respective processor of each of the plurality of computing devices to perform the steps of receiving the first shared digital document data and the second shared digital document data from the database/server over the network, displaying one or both of the first and second shared digital document data as a respective first or second shared digital document on a respective display of each of the plurality of computing devices, allowing a first annotation of the first shared digital document via a respective input device associated with any of the plurality of computing devices, wherein the first annotation produces a first annotated digital document which includes the first shared digital document data and first annotated digital document data wherein the first annotated digital document data overlays the first shared digital document without modification to the first original document data, allowing a second annotation of the second shared digital document via a respective input device associated with any of the plurality of computing devices, wherein the second annotation produces a second annotated digital document which includes the second shared digital document data and second annotated digital document data wherein the second annotated digital document data overlays the second shared digital document without modification to the second original document data, and generating a marker report including each of the first annotation and the second annotation.

The marker report further includes one or more of an identification of a respective shared digital document associated with each of the first annotation and the second annotation, an identification of a respective computing device of the plurality of computing devices which created each of the first annotation and the second annotation, an identification of a type of annotation of each of the first annotation and the second annotation, a reproduction of each respective annotation, and a status of each respective annotation. In a further aspect of the invention, any one or more of the above identifications may also operate as a hyperlink whereby actuation of the identification hyperlink directs the user to the document and annotation referenced by that hyperlink.

From the foregoing, it will be seen that this invention is one well adapted to attain all the ends and objects hereinabove set forth together with other advantages which are obvious and which are inherent to the system and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A computer-implemented digital content collaboration system for facilitating annotation of an original digital content file comprising original digital content data between a first computing device and a second computing device, the system comprising:
a) a database/server including a memory and a processor, wherein the database/server is in communication with the first computing device and the second computing device over a network;
b) a first set of computer instructions that when executed by the processor of the database/server performs the steps of:
i) storing a shared digital content file comprising shared digital content data, wherein the shared digital content data includes the original digital content data, and
ii) communicating the shared digital content data to the second computing device over the network, and
c) a second set of computer instructions configured for being stored in a respective memory of the first computing device and the second computing device, the second set of computer instructions configured for being executed by a respective processor of the first computing device and the second computing device to perform the steps of:
i) receiving the shared digital content data from the database/server over the network,
ii) displaying the shared digital content data as the shared digital content file on a respective display of the first computing device and the second computing device,
iii) allowing annotation of the shared digital content file via a respective input device associated with the first computing device and the second computing device, wherein the annotation produces an annotated digital content file which includes the shared digital content data and annotated digital content data wherein the annotated digital content data overlays the shared digital content without modification to the original digital content data,
iv) communicating the annotated digital content data to the database/server over the network,
v) receiving, at the first computing device and the second computing device, the annotated digital content data from the database/server over the network,
vi) displaying the annotated digital content file including each annotation of the plurality of annotations on the respective display of the first computing device and the second computing device; and
vii) allowing modification of the original digital content data at only the first computing device.

2. A computer-implemented digital content collaboration system comprising:
a) a database/server including a memory and a processor, wherein the database/server is in communication with each respective computing device of a plurality of computing devices over a network;
b) a first set of computer instructions that when executed by the processor of the database/server performs the steps of:
i) storing a first shared digital content file comprising first shared digital content data, wherein the first shared digital content data includes first original digital content data associated with a first original digital content file,
ii) storing a second shared digital content file comprising second shared digital content data, wherein the second shared digital content data includes second original digital content data associated with a second original digital content file, and
iii) communicating the first shared digital content data and the second shared digital content data to each of the plurality of computing devices over the network, and
c) a second set of computer instructions configured for being stored in a respective memory of each of the plurality of computing devices, the second set of computer instructions configured for being executed by a respective processor of each of the plurality of computing devices to perform the steps of:
i) receiving the first shared digital content data and the second shared digital content data from the database/server over the network,
ii) displaying one or both of the first shared digital content data and the second shared digital content data as a respective first shared digital content file or second shared digital content file on a respective display of each of the plurality of computing devices,
iii) allowing a first annotation of the first shared digital content via a respective input device associated with any of the plurality of computing devices, wherein the first annotation produces a first annotated digital content file which includes the first shared digital content data and first annotated digital content data wherein the first annotated digital content data overlays the first shared digital content without modification to the first original digital content data,
iv) allowing a second annotation of the second shared digital content via a respective input device associated with any of the plurality of computing devices, wherein the second annotation produces a second annotated digital content file which includes the second shared digital content data and second annotated digital content data wherein the second annotated digital content data overlays the second shared digital content without modification to the second original digital content data,
v) allowing cross-referencing of the first annotation with the second annotation wherein the first shared digital content includes a first hyperlink to the second shared digital content.

3. The system of claim 2 wherein the first hyperlink is directed to a location of the second annotation within the second shared digital content.

4. The system of claim 3 wherein the second shared digital content includes a second hyperlink to the first shared digital content.

5. The system of claim 4 wherein the second hyperlink is directed to a location of the first annotation within the first shared digital content.

6. A computer-implemented digital content collaboration system comprising:
a) a database/server including a memory and a processor, wherein the database/server is in communication with each respective computing device of a plurality of computing devices over a network;
b) a first set of computer instructions that when executed by the processor of the database/server performs the steps of:
i) storing a first shared digital content file comprising first shared digital content data, wherein the first shared digital content data includes first original digital content data associated with a first original digital content file,
ii) storing a second shared digital content file comprising second shared digital content data, wherein the second shared digital content data includes second original digital content data associated with a second original digital content file, and
iii) communicating the first shared digital content data and the second shared digital content data to each of the plurality of computing devices over the network, and
c) a second set of computer instructions configured for being stored in a respective memory of each of the plurality of computing devices, the second set of computer instructions configured for being executed by a respective processor of each of the plurality of computing devices to perform the steps of:
i) receiving the first shared digital content data and the second shared digital content data from the database/server over the network,
ii) displaying one or both of the first and second shared digital content data as a respective first shared digital content file or second shared digital content file on a respective display of each of the plurality of computing devices,
iii) allowing a first annotation of the first shared digital content file via a respective input device associated with any of the plurality of computing devices, wherein the first annotation produces a first annotated digital content file which includes the first shared digital content data and first annotated digital content data wherein the first annotated digital content data overlays the first shared digital content file without modification to the first original content data,
iv) allowing a second annotation of the second shared digital content file via a respective input device associated with any of the plurality of computing devices, wherein the second annotation produces a second annotated digital content file which includes the second shared digital content data and second annotated digital content data wherein the second annotated digital content data overlays the second shared digital content file without modification to the second original content data,
v) generating a marker report including each of the first annotation and the second annotation, wherein the marker report further includes one or more of the following fields:
a) an identification of a respective shared digital content file associated with each of the first annotation and the second annotation,
b) an identification of a respective computing device of the plurality of computing devices which created each of the first annotation and the second annotation,
c) an identification of a type of annotation of each of the first annotation and the second annotation,
d) a reproduction of each respective annotation, and
e) a status of each respective annotation.

7. The system of claim 6 wherein one or more of each field a) through e) is an operable hyperlink wherein selection of a specific field directs a user from the marker report to the first or second annotation within the first shared digital content file or the second shared digital content file linked to the specific field.
